(19) United States
(12) Patent Application Publication
(10) Pub. No.: US 2007/0166462 A1
(43) Pub. Date: Jul. 19, 2007

(54) Method and system for producing a wood-free coated matte or semi-matte paper web

(76) Inventors: Reinhard Leigraf, Fronreute (DE); Susanne Berger, Heidenheim (DE); Bernd Gueldenberg, Heidenheim (DE)

Correspondence Address: TAYLOR & AUST, P.C., 142 SOUTH MAIN STREET, P. O. BOX 560, AVILLA, IN, 46710, US

(21) Appl. No.: 10/587,617

(22) PCT Filed: Dec. 21, 2004
(86) PCT No.: PCT/EP04/53630

§ 371 Date: Jul. 27, 2006

(30) Foreign Application Priority Data
Jan. 27, 2004 (DE) 10 2004 003 921.6

(51) Int. Cl. B05D 3/02; B05D 7/00; B05C 11/00

(52) U.S. Cl. 427/314; 427/407.1; 427/372.2; 118/67

(57) ABSTRACT

A method for the production of a wood-free coated, matt or semi-matt paper web, including the steps of precalendering, coating and drying. The precalendering step includes precalendering the paper web using at least one apparatus for precalendering. The coating step includes coating at least one side of the paper web by using at least one apparatus for applying one of a liquid and pasty application medium. The drying step includes drying the paper web using at least one apparatus for drying the paper web. The method creates the wood-free coated paper web with a roughness level in the range from 0.8 to 3.9 μm PPS (Parker Print Surf) and a gloss value in the range from 3 to 35% TAPPI 75° (Specular Gloss of Paper and Paperboard at 75°).

This invention relates to a method and an arrangement for the production of a wood-free coated, matt or semi-matt paper web.

Nowadays, wood-free coated (WFC) papers are coated once or several times and then calendered slightly or not at all. Between the gloss and the roughness of the paper there exists in this case a fixed dependency or relation which can be changed within certain but greatly restricted limits only by manipulating the coating recipe. The finish of the paper is very largely defined moreover by the possible calendering process.

On account of said dependency, only the production of a wood-free coated paper web with limited qualities is possible.

The object of this invention is therefore to disclose a method and an arrangement for the production of a wood-free coated paper web, which permit the production of paper webs in new quality ranges, in particular for matt and semi-matt WFC grades.

This object is accomplished with a method according to the invention in that the paper web is precalendered by means of at least one apparatus for precalendering, then coated at least on one side by means of at least one apparatus for applying a liquid or pasty application medium and finally dried by at least one apparatus for drying in order, as the result, to create a wood-free coated, matt or semi-matt paper web with a roughness level in the range from 0.8 to 3.9 μm [PPS] and a gloss value in the range from 3 to 35% [TAPPI 75°].

This combination according to the invention permits the entry into new quality ranges for WFC grades, in particular for matt and semi-matt WFC grades. Thanks to the method according to the invention, the coated paper can be produced with less impact on its volume and the required calendering work can be significantly reduced. In particular for single-coated paper webs, meaning for non-precoated paper webs, the roughness level of the paper web after the precalendering, being less than 6 μm, in particular less than 5 μm, is equal to or greater than 1.4 times the final roughness of the finished paper web. Hence the possibility of producing a paper web with a very low roughness level and a very small gloss value is provided.

As such, the universally known dependency between the roughness and the gloss is greatly reduced with the new process, as the result of which the production of new paper qualities becomes possible.

Special attention is paid in this connection to the precalendering directly prior to the final application: The desired smoothness must be produced here already in order for the desired finish to be obtained after the following application, in particular by means of non-contact curtain coating. By doing without the hitherto customary calendering after the final application it is possible to obtain the required gloss solely through the composition of the application medium.

The precalendering is also very advantageous for the application, in particular by means of non-contact curtain coating, as the requirements imposed on the viscoelasticity of the application medium are reduced as the result and a good application quality is assured.

Furthermore, the entire process for the production of wood-free coated, matt or semi-matt paper webs is simplified as the hitherto customary finishing is no longer required and the entire process can be designed preferably as an online process.

In a first preferred embodiment the paper web is coated prior to its precalendering by means of at least one apparatus for applying liquid or pasty application medium. The coating takes place preferably on a first side once by means of a film or curtain coating device, on both sides once by means of a film coating device or on both sides once by means of a curtain coating device. The compositions of the coating colors, the respective coating weights and the like can vary in this case.

After this coating, the paper web is dried in known manner.

Furthermore, provision can be made for the paper web to be conveyed through at least one film press prior to the first application of liquid of pasty application medium. A possible first thickness calibration of the paper web is thus realized in effective and simple manner.

In a further preferred embodiment the paper web is precalendered by means of a smoothing unit, by means of a shoe calender with at least one extended nip and a smoothing unit, by means of a soft calender with at least one nip, or by means of a super calender with at least one nip. These apparatuses for precalendering are excellently suited for the purpose and are characterized by a level of process reliability necessary for the production process according to the invention as well as by beneficial operating costs.

The paper web is then coated once on a first side by means of an apparatus for applying liquid or pasty application medium, in particular a curtain coating device. In addition or alternatively to this, the paper web is coated once also or only on a second side by means of a further apparatus for applying liquid or pasty application medium, in particular a curtain coating device. The composition of the at least one coating color, the coating weight and the like can vary in this case.

After this coating, the paper web is dried for the first time or again in known manner.

Once again provision can be made for the paper web to be conveyed through at least one film press prior to its precalendering, assuming that the paper web is coated only once. A possible first thickness calibration of the paper web is thus realized in effective and simple manner.

The object of the invention is accomplished with an arrangement of the invention in that it has, in the running direction of the paper web, at least one apparatus for precalendering the paper web, at least one apparatus for applying liquid or pasty application medium onto the paper web and at least one apparatus for drying the paper web.

In a first preferred embodiment, at least one further apparatus for applying liquid or pasty application medium to the paper web and one further apparatus for drying the paper web are arranged, in the running direction of the paper web, upstream from the apparatus for precalendering the paper web.

The apparatus for precalendering the paper web comprises preferably at least one smoothing unit, one soft calender with at least one nip, one super calender with at least one nip or one shoe calender with at least one extended nip.

In this case the smoothing unit can have two hard-cast rollers, the soft calender one hard-cast roller and one roller equipped with a plastic covering, and the super calender one hard-cast roller and a paper roller, whereby said roller pairs together form a nip.

Furthermore, the apparatus for applying liquid or pasty application medium is one which works in non-contact mode or one which makes contact with the paper web.

In this case the apparatus working in non-contact mode can have a curtain coating device or a spray coating device and the apparatus making contact with the paper web a jet flow coating device or a film coating device.

The apparatus for drying the paper web has an impingement dryer and/or an IR drying unit. These drying apparatuses are excellently suited for the purpose and are characterized by a level of process reliability necessary for the production process according to the invention as well as by beneficial operating costs.

In a supplementary embodiment at least one film press can be arranged, in the running direction of the paper web, upstream from the apparatus for precalendering the paper web or the apparatus for applying liquid or pasty application medium to the paper web. A possible first thickness calibration of the paper web is thus realized in effective and simple manner.

In a special embodiment it is also possible for the arrangement according to the invention to form a unit with a paper machine. The wood-free coated, matt or semi-matt paper web can thus be produced online and hitherto necessary process steps such as, for example, the unwinding and rewinding of the paper web during the production process are no longer necessary.

Further features and advantages of the invention result from the following description of preferred exemplary embodiments, with reference to the drawing.

In the drawing:

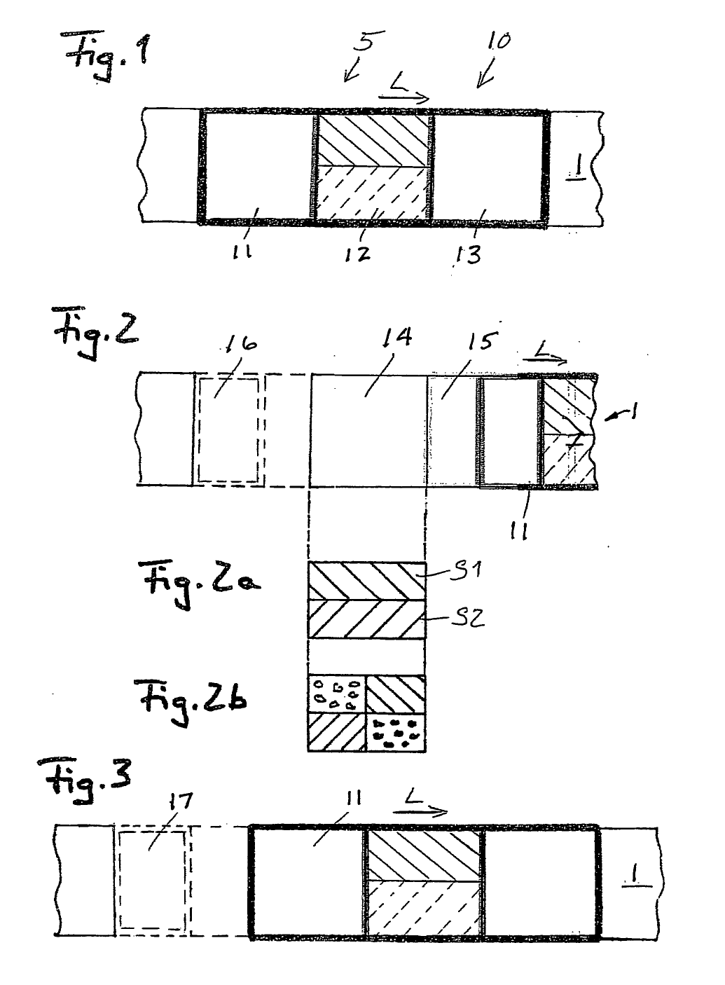

FIG. 1 is a schematic representation of an arrangement according to the invention;

FIGS. 2a and 2b are further schematic representations of two arrangements according to the invention;

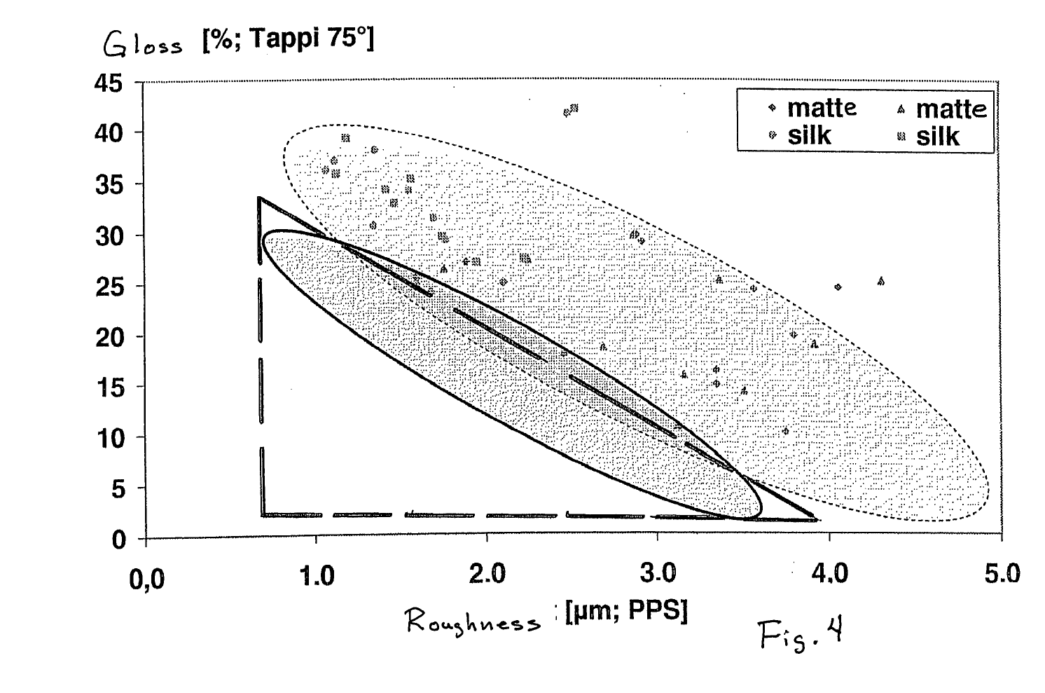

FIG. 3 is a further schematic representation of an arrangement according to the invention, and

FIG. 4 is a roughness/gloss diagram according to the invention.

FIG. 1 shows a schematic representation of an arrangement 10 according to the invention for the production of a wood-free coated, matt or semi-matt paper web 1.

The paper machine 5 for the production of the paper web 1 comprises in known manner a headbox, a mesh section, a press section, a drying section and a winder, all of which are not explicitly shown. The general construction of a paper machine and its sections is described in numerous publications and well known to those skilled in the art.

The arrangement 10 has in running direction L (arrow) of the paper web 1 at least one apparatus 11 for precalendering the paper web 1, at least one apparatus 12 for applying liquid or pasty application medium to the paper web 1 and at least one apparatus 13 for drying the paper web 1.

The apparatus 11 for precalendering the paper web 1 comprises at least one smoothing unit, one soft calender with at least one nip, one super calender with at least one nip or one shoe calender with at least one extended nip.

In this case the smoothing unit can have two hard-cast rollers, the soft calender one hard-cast roller and one roller equipped with a plastic covering, and the super calender one hard-cast roller and a paper roller, whereby said roller pairs together form a nip. A soft calender with several rollers is known from the European patent specification EP 0 732 446 B.

Furthermore, the apparatus 12 for applying liquid or pasty application medium is one which works in non-contact mode or one which makes contact with the paper web 1.

In this case the apparatus working in non-contact mode can have a curtain coating device or a spray coating device and the apparatus making contact with the paper web a jet flow coating device or a film coating device. A curtain coating method complete with application device is known, for example, from the German publication of unexamined application DE 100 12 344 A1 and from the VOITH publication “Der DF-Coater—eine Streichtechnik der neuen Generation”, twogether Special Edition “Systems for Finishing”, Hirofumi Morita, p3326 d 03.03.

The apparatus 13 for drying the paper web 1 has an impingement dryer and/or an IR drying unit. Needless to say, however, other drying systems and principles may also be used.

The apparatuses 11, 12 and 13 are shown with a bold border in the schematic representation in order to lend expression to their importance.

Thanks to this arrangement 10 it is thus possible to perform the method according to the invention. Said method is characterized in that the paper web 1 is precalendered by means of at least one apparatus 11 for precalendering, then coated at least on one side by means of at least one apparatus 12 for applying liquid or pasty application medium and finally dried by at least one apparatus 13 for drying in order, as the result, to create a wood-free coated, matt or semi-matt paper web 1 with a roughness level in the range from 0.8 to 3.9 μm [PPS] and a gloss value in the range from 3 to 35% [TAPPI 75°].

In FIG. 1 it can be clearly seen that the apparatuses 11, 12 and 13, as a part of the arrangement 10, form a unit with the paper machine 5. Hence the process steps according to the invention take place online in the production of the wood-free coated, matt or semi-matt paper web 1.

FIGS. 2a and 2b show further schematic representations of two embodiments according to the invention.

In this case at least one further apparatus 14 for applying liquid or pasty application medium to the paper web 1 and one further apparatus 15 for drying the paper web 1 are arranged, in the running direction L (arrow) of the paper web 1, upstream from the apparatus 11 for precalendering the paper web 1.

Moreover, the further apparatus 14 for applying liquid or pasty application medium to the paper web 1 is one which works in non-contact mode or one which makes contact with the paper web 1 (cf. FIG. 1). It is configured preferably as a film or a curtain coating device and coats the paper web 1 once on a first side S1 or once on both sides S2. The one-sided coating of the paper web 1 can take place on the top or bottom side and the two-sided coating of the paper web 1 can take place simultaneously (cf. FIG. 2a), in overlapping periods of time or in staggered periods of time (cf. FIG. 2b).

Also, the further apparatus 15 for drying the paper web 1 has an impingement dryer and/or an IR drying unit (cf. FIG. 1). Needless to say, however, other drying systems and principles may also be used.

At least one film press 16 of known design and mode of operation (represented by double dashed lines) for the possible first thickness calibration of the still uncoated paper web 1 is arranged, 1 in the running direction L (arrow) of the paper web 1, upstream from the further apparatus 14 for applying liquid or pasty application medium to the paper web. Between the film press 16 and the apparatus 14 it is possible of course for further units and apparatuses of known type (represented by dashed lines) to be arranged in order to contribute to the production process for the wood-free coated, matt or semi-matt paper web 1.

FIG. 3 shows a further schematic representation of an embodiment according to the invention.

This arrangement 10 is similar in principle to the arrangement 10 in FIG. 1, to which reference is made herewith.

In this case provision is made for at least one film press 17 (represented by double dashed lines) of known design and mode of operation for the possible first thickness calibration of the still uncoated paper web 1 to be arranged, in running direction L (arrow) of the paper web 1, upstream from the apparatus 11 for applying liquid or pasty application medium to the paper web 1. Between the film press 17 and the apparatus 11 it is possible of course for further units and apparatuses of known type (represented by dashed lines) to be arranged in order to contribute to the production process for the wood-free coated, matt or semi-matt paper web 1.

FIG. 4 shows is a roughness/gloss diagram according to the invention.

It is clear to see that in the prior art a distinct dependency exists between the roughness and the gloss of a paper web (dashed area). This is owed to the fact that both quality characteristics are established by only one step (postcalendering). Small gloss values with low roughness levels are not possible, which in the case of matt paper grades is a disadvantage.

With the method of the invention, on the other hand, it is possible to establish small gloss values with low roughness levels This is because the roughness is defined by the precalendering and in combination with the non-contact coating is no longer worsened. A contour coat is applied during the non-contact coating. The advantage of this is that the application medium is not pressed into the paper web during the coating, which would lead to a certain wetting of the paper web and hence to an increase in the roughness of the paper web. The gloss of the paper web is thus established independently of the calendering work through the parameters of the application medium. These parameters are, for example, the consistency, the recipe, the size and form of the pigment particles and the like.

Through the precalendering, far better conditions for the non-contact application method are created. This leads, among other things, to better coating results due to lower requirements imposed on the viscoelasticity of the application medium.

Using the process steps according to the invention it is thus possible to produce a wood-free coated, matt or semi-matt paper web in new quality ranges. The new quality ranges lie within a triangular, preferably elliptical contour which extends in the roughness range from 0.8 to 3.9 μm [PPS] and in the gloss range from 3 to 35% [TAPPI 75°] and is represented in FIG. 4 in full-dashed or full-lined form.

For a clear reflection of the significance of the invention, the quality ranges of wood-free coated paper webs produced in accordance with the production methods known hitherto are shown in FIG. 4. These ranges lie likewise within a preferably elliptical contour, which however has less favorable quality values and is represented in dashed form.

In summary it is to be recorded that, by means of the invention, a method and an arrangement for the production of a wood-free coated, matt or semi-matt paper web are created which permit the production of paper webs in new quality ranges, in particular for matt and semi-matt WFC grades.

### LIST OF REFERENCE NUMERALS

1 Paper web
5 Paper machine
10 Arrangement
11 Apparatus (precalendering)
12 Apparatus (application)
13 Apparatus (drying)
14 Apparatus (application)
15 Apparatus (drying)
16 Film press
17 Film press
L Running direction (arrow)
S1 Second side (paper web)
S2 Second side (paper web)

1-25. (canceled)

26. A method for the production of a wood-free coated, matt or semi-matt paper web, comprising the steps of:
precalendering the paper web using at least one apparatus for precalendering;
coating at least one side of the paper web by using at least one apparatus for applying one of a liquid and pasty application medium; and
drying the paper web using at least one apparatus for drying the paper web thereby creating the wood-free coated paper web with a roughness level in the range from 0.8 to 3.9 μm PPS (Parker Print Surf) and a gloss value in the range from 3 to 35% TAPPI 75° (Specular Gloss of Paper and Paperboard at 75°).

27. The method of claim 26, further comprising the step of coating the paper web on a first side by way of an other apparatus for applying said one of a liquid and pasty application medium prior to said precalendering step

28. The method of claim 27, wherein said other apparatus is one of a film coating device and a curtain coating device.

29. The method of claim 26, wherein said coating step is carried out once on both sides of the paper web prior to said precalendering step, said at least one apparatus for applying one of a liquid and pasty application medium being a film coating device.

30. The method of claim 26, wherein said at least one apparatus for applying one of a liquid and pasty application medium includes a first apparatus and a second apparatus each being a curtain coating device.

31. The method of claim 26, further comprising the step of drying the paper web.

32. The method of claim 27, further comprising the step of conveying the paper web through at least one film press prior to a coating step.

33. The method of claim 26, wherein said apparatus for precalendering is one of a shoe calender with at least one extended nip and a smoothing unit, a soft calender with at least one nip and a super calender with at least one nip.

34. The method of claim 33, wherein said at least one apparatus for applying one of a liquid and pasty application medium includes a first apparatus that coats a first side of the paper web, said first apparatus being a curtain coating device.

35. The method of claim 34, wherein said at least one apparatus for applying one of a liquid and pasty application medium includes a second apparatus that coats a second side of the paper web, said second apparatus being a curtain coating device.

36. The method of claim 35, further comprising the step of drying the paper web.

37. The method of claim 26, further comprising the step of conveying the paper web through at least one film press prior to said precalendering step.

38. The method of claim 26, wherein the paper web is not conveyed through any smoothing apparatus nor is the paper web conveyed through any calendering apparatus after the paper web has been coated by said at least one apparatus for applying one of a liquid and pasty application medium in a running direction L.

39. An arrangement for the production of a wood-free coated, matt or semi-matt paper web, comprising:
at least one precalendering apparatus for precalendering the paper web;
at least one coating apparatus for applying one of a liquid and pasty application medium to the paper web; and
at least one dryer for drying the paper web.

40. The arrangement of claim 39, wherein said at least one coating apparatus includes a first coating apparatus and a second coating apparatus, said at least one dryer including a first dryer and a second dryer, the paper web moving in a running direction L, said second coating apparatus and said second dryer being upstream from said at least one precalendering apparatus in said running direction L.

41. The arrangement of claim 40, wherein said at least one precalendering apparatus includes at least one of a smoothing unit, a soft calender with at least one nip, a super calender with at least one nip and a shoe calender with at least one extended nip.

42. The arrangement of claim 41, wherein said at least one precalendering apparatus is said smoothing unit having two hard-cast rollers, which together form a nip.

43. The arrangement of claim 41, wherein said at least one precalendering apparatus is said soft calender having one hard-cast roller and one roller equipped with a plastic covering, which together form a nip.

44. The arrangement of claim 41, wherein said at least one precalendering apparatus is said super calender having one hard-cast roller and one paper roller, which together form a nip.

45. The arrangement of claim 39, wherein said at least one coating apparatus is one of which makes contact with the paper web and one which works in a non-contact mode.

46. The arrangement of claim 45, wherein said at least one coating apparatus is one of a jet flow coating device and a film coating device.

47. The arrangement of claim 45, wherein said at least one coating apparatus is one of a curtain coating device and a spray coating device.

48. The arrangement of claim 39, wherein said at least one dryer is at least one of an impingement dryer and an IR drying unit.

49. The arrangement of claim 39, further comprising at least one film press arranged in a running direction (L) of the paper web upstream from at least one of said at least one precalendering apparatus and said at least one coating apparatus.

50. The arrangement of claim 39, wherein the arrangement forms a unit with a paper machine.

51. The arrangement of claim 39, wherein nether a smoothing nor a calendering apparatus is arranged, in a running direction L of the paper web, upstream from said precalendering apparatus and said coating apparatus.
